(19) United States
(12) Patent Application Publication
(10) Pub. No.: US 2024/0430888 A1
(43) Pub. Date: Dec. 26, 2024

(54) GRANT SKIPPING FOR A SMALL DATA TRANSMISSION PROCEDURE

(71) Applicant: Nokia Technologies Oy, Espoo (FI)

(72) Inventors: Samuli Heikki TURTINEN, Oulu (FI); Benoist Pierre SEBIRE, Tokyo (JP); Chunli WU, Beijing (CN); Jussi-Pekka KOSKINEN, Oulu (FI)

(21) Appl. No.: 18/575,155

(22) PCT Filed: Aug. 3, 2021
(86) PCT No.: PCT/CN2021/110235

§ 371 Date: Dec. 28, 2023

(51) Int. Cl. H04W 72/1268

(52) U.S. Cl. CPC H04W 72/1268

(57) ABSTRACT

Example embodiments of the present disclosure relate to grant skipping for a small data transmission (SDT) procedure. A first device determines whether data is available for transmission on a grant, the grant being allocated for a SDT procedure established between the first device and a second device. In accordance with a determination that the data is unavailable, the first device determines whether the transmission on the grant is to be skipped. In accordance with a determination that the transmission on the grant is not to be skipped, the first device performs the transmission on the grant to the second device, the transmission conveying a predetermined type of information without conveying the data. Through this solution, the SDT procedure between the devices can be maintained as long as possible, to allow the first device to transmit subsequent data to or receive subsequent data from the second device without initiating a new SDT procedure.

### FIELD

Embodiments of the present disclosure generally relate to the field of telecommunication and in particular, to devices, methods, apparatuses and computer readable storage medium for grant skipping for a small data transmission (SDT) procedure.

### BACKGROUND

In some communication systems, a communication device can transition between an inactive state and a connected state. In the inactive state, the communication device may not have a connection established with a network device for communications. To avoid unnecessary signaling overhead and power consumption for establishing or reestablishing a connection, the communication device in the inactive state may perform a small data transmission (SDT) procedure with other communication device, without requiring establishing a connection with the other communication device.

### SUMMARY

In general, example embodiments of the present disclosure provide a solution for grant skipping for a SDT procedure. Embodiments that do not fall under the scope of the claims, if any, are to be interpreted as examples useful for understanding various embodiments of the disclosure.

In a first aspect, there is provided a first device. The first device comprises at least one processor; and at least one memory including computer program code; where the at least one memory and the computer program code are configured to, with the at least one processor, cause the first device to: determine whether data is available for transmission on a grant, the grant being allocated for a small data transmission procedure established between the first device and a second device; in accordance with a determination that the data is unavailable, determine whether the transmission on the grant is to be skipped; and in accordance with a determination that the transmission on the grant is not to be skipped, perform the transmission on the grant to the second device, the transmission conveying a predetermined type of information without conveying the data.

In a second aspect, there is provided a second device. The second device comprises at least one processor; and at least one memory including computer program code; where the at least one memory and the computer program code are configured to, with the at least one processor, cause the second device to: establish a small data transmission procedure with a first device; receive, from the first device on a grant allocated for the small data transmission procedure, a transmission conveying a predetermined type of information without conveying data; and cause the small data transmission procedure to be maintained based on the reception of the transmission on the grant.

In a third aspect, there is provided a method. The method comprises determining, at a first device, whether data is available for transmission on a grant, the grant being allocated for a small data transmission procedure established between the first device and a second device; in accordance with a determination that the data is unavailable, determining whether the transmission on the grant is to be skipped; and in accordance with a determination that the transmission on the grant is not to be skipped, performing the transmission on the grant to the second device, the transmission conveying a predetermined type of information without conveying the data.

In a fourth aspect, there is provided a method. The method comprises establishing, at a second device, a small data transmission procedure with a first device; receiving, from the first device on a grant allocated for the small data transmission procedure, a transmission conveying a predetermined type of information without conveying data; and causing the small data transmission procedure to be maintained based on the reception of the transmission on the grant.

In a fifth aspect, there is provided a first apparatus. The first apparatus comprises means for determining whether data is available for transmission on a grant, the grant being allocated for a small data transmission procedure established between the first apparatus and a second apparatus; means for, in accordance with a determination that the data is unavailable, determining whether the transmission on the grant is to be skipped; and means for, in accordance with a determination that the transmission on the grant is not to be skipped, performing the transmission on the grant to the second apparatus, the transmission conveying a predetermined type of information without conveying the data.

In a sixth aspect, there is provided a second apparatus. The second apparatus comprises means for establishing a small data transmission procedure with a first apparatus; means for receiving, from the first apparatus on a grant allocated for the small data transmission procedure, a transmission conveying a predetermined type of information without conveying data; and means for causing the small data transmission procedure to be maintained based on the reception of the transmission on the grant.

In a seventh aspect, there is provided a computer readable medium. The computer readable medium comprises program instructions for causing an apparatus to perform at least the method according to the third aspect or the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a flowchart of an example process implemented at a first device according to some example embodiments of the present disclosure;

FIG. 3 illustrates an example of grant skipping at the first device 110 according to some example embodiments of the present disclosure;

FIG. 4 illustrates a flowchart of an example process implemented at a second device in accordance with some example embodiments of the present disclosure;

FIG. 5 illustrates a simplified block diagram of a device that is suitable for implementing example embodiments of the present disclosure; and

FIG. 6 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, a resource in both frequency domain and time domain will be used as an example of a transmission resource for describing some example embodiments of the present disclosure. It is noted that example embodiments of the present disclosure are equally applicable to other resources in other domains.

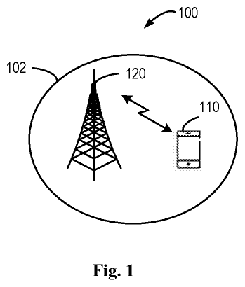

FIG. 1 shows an example communication environment 100 in which example embodiments of the present disclosure can be implemented. In the communication environment 100, a plurality of communication devices, including a first device 110 and a second device 120 can communicate with each other.

In the example of FIG. 1, the first device 110 is illustrated as a terminal device while the second device 120 is illustrated as a network device serving the terminal device. The serving area of the second device 120 may be called a cell 102.

It is to be understood that the number of devices and their connections shown in FIG. 1 are only for the purpose of illustration without suggesting any limitation. The environment 100 may include any suitable number of devices adapted for implementing embodiments of the present disclosure. Although not shown, it would be appreciated that one or more additional devices may be located in the cell 102, and one or more additional cells may be deployed in the environment 100. It is noted that although illustrated as a network device, the second device 120 may be other device than a network device. Although illustrated as a terminal device, the first device 110 may be other device than a terminal device.

In some example embodiments, if the first device 110 is a terminal device and the second device 120 is a network device, a link from the second device 120 to the first device 110 is referred to as a downlink (DL), while a link from the first device 110 to the second device 120 is referred to as an uplink (UL). In DL, the second device 120 is a transmitting (TX) device (or a transmitter) and the first device 110 is a receiving (RX) device (or a receiver). In UL, the first device 110 is a TX device (or a transmitter) and the second device 120 is a RX device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

During operation, a device (e.g., a terminal device) can transition between an inactive state and a connected state. The inactive state may sometimes be referred to as an inactive mode, an RRC_INACTIVE state/mode, and such terms are used interchangeably herein. The connected state may sometimes be referred to as a connected mode, an active state/mode, or an RRC_CONNECTED state/mode, and such terms are used interchangeably herein.

Generally, there is a certain amount of signaling overhead and power consumption to transition a terminal device from an inactive state to a connected state by establishing or reestablishing a connection between the terminal device and the network device. If connection setup and subsequently release happens for at least one data transmission of the terminal device in the inactive state no matter how small and infrequent the data packets are, it may result in unnecessary power consumption and signalling overhead. Currently, the terminal device may be able to initiate a small data transmission (SDT) procedure, for example, when the terminal device is in the inactive state. As used herein, the term “SDT” refers to a type of transmission where a small amount of data is transmitted, although other terms may also be used. The SDT procedure allows the terminal device to perform infrequent (periodic and/or non-periodic) data transmissions.

There are various applications that involve exchange of relatively small amounts of data. For example, in some applications of mobile devices, SDT may include traffic from Instant Messaging (IM) services, heart-beat or keep-alive traffic from IM or email clients and other services, push notifications from various applications, traffic from wearables (including, for example, periodic positioning information), and/or the like. In some applications of non-mobile device applications, SDT may include sensor data (e.g., temperature, pressure readings transmitted periodically or in an event-triggered manner in an IoT network), metering and alerting information sent from smart meters, and/or the like.

Signalling overhead and delay for a device in the inactive state for small data packets is a general problem, not only for network performance and efficiency but also for the battery performance. In general, any device that has intermittent small data packets in the inactive state will benefit from enabling SDT. In some example embodiments, a device may initiate SDT through a random access channel (RACH) procedure, such as a 4-step or 2-step RACH procedure or using configured grant (CG) resources. For example, for 4-step RACH based SDT, the Msg3, e.g., a physical uplink shared channel (PUSCH), may be used by a terminal device to transmit data; for 2-step RACH based SDT, the MsgA, e.g., PUSCH, may be used by a terminal device to transmit data; and for CG-based SDT, a CG resource (such as a CG type 1 based PUSCH resource) may be used by a terminal device to transmit data if the terminal device has a valid timing advance (TA). In the CG-based SDT, no RACH procedure is required.

Further, it is also supported that a device can perform one or more subsequent data transmissions after an initial SDT transmission during a SDT procedure. Such a SDT procedure may be called multi-shot SDT procedure. The subsequent data transmissions may be scheduled via grants such as dynamic grants or configured grants. In some example embodiments, it may be under network control to make state transition decisions to determine when a SDT procedure ends and to which state a terminal device should transition.

It is specified that UL grant skipping is required to be performed by a terminal device for an UL grant when the terminal device has no data to transmit. In the case of a SDT procedure having been initiated, if the terminal device skips an UL grant, the network device may assume that the terminal device has no more data to transmit and may, hence, end the SDT procedure. However, it is possible that the terminal device will have more data to be transmitted to or received from the other device, ending the SDT procedure too early may cause the terminal device to subsequently initiate a new SDT procedure, which will increase signalling overhead and thus is undesirable.

According to some example embodiments of the present disclosure, there is provided a solution for grant skipping in a SDT procedure. In this solution, if a first device has no data available for transmission on a grant during a SDT procedure with a second device, the first device determines whether the transmission on the grant is to be skipped. If the transmission on the grant is not to be skipped, the first device proactively performs the transmission on the grant by conveying certain information without conveying data (in some examples, the “data” here refers to MAC SDU (media access control service data unit)). Upon reception of such a transmission on the grant, the second device may not end the current SDT procedure. As such, the SDT procedure between the first device and the second device can be maintained as long as possible, to allow the first device to transmit subsequent data to or receive subsequent data from the second device without initiating a new SDT procedure. The signaling overhead and power consumption of the first device may thus be decreased.

Example embodiments of the present disclosure will be described in detail below with reference to the accompanying drawings.

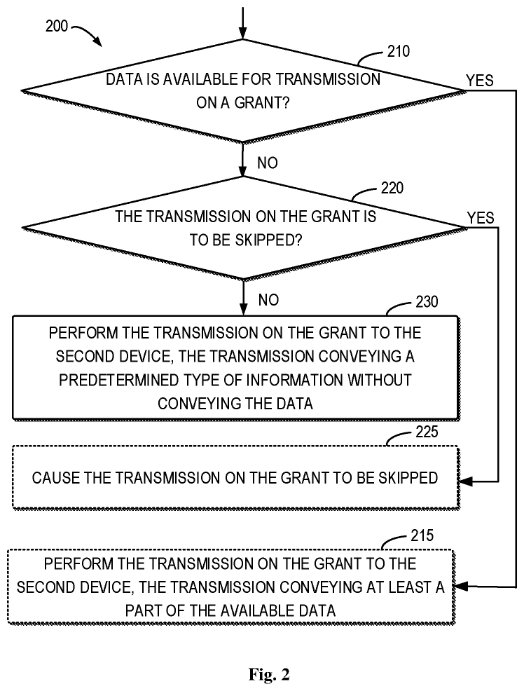

Reference is now made to FIG. 2, which shows a flowchart of an example process 200 implemented at a first device according to some example embodiments of the present disclosure. For the purpose of discussion, reference will be made to the communication environment 100 shown in FIG. 1 and the process 200 will be described from the perspective of the first device 110 in the communication environment 100.

In operation, the first device 110 can initiate and establish a SDT procedure with the second device 120 in order to communicate small data with the second device 120. In some cases, as mentioned above, the first device 110 is allowed to perform one or more subsequent data transmissions after an initial transmission during the SDT procedure. To support the subsequent transmission(s), the first device 110 may be allocated with more than one grant, for example, by the second device 120. As used herein, a grant may comprise one or more time-frequency resources. In some example embodiments, the grants allocated to the first device 110 for the SDT procedure may be one or more configured grants, and/or one or more dynamic grants. In some example embodiments, the grants may have a certain periodicity although in some examples grants without periodicity may also be allocated to the first device 110. In the cases where the first device 110 is a terminal device and the second device 120 is a network device, the grants may also be referred to as UL grants.

The first device 110 can determine whether a transmission is to be performed on a grant. In the process 200, at block 210, the first device 110 determines whether data is available for transmission on a grant allocated for the SDT procedure. For example, the first device 110 may determine whether there is data stored in a buffer(s) for transmission. In some example embodiments, SDT may be enabled or configured for one or more of the radio bearers or one or more of the logical channels (LCHs). In some example embodiments, one or more logical channel groups (LCGs) corresponding to the radio bearer(s) or the LCH(s) may also be taken into account. If the first device 110 determines that the SDT is enabled or configured for a certain radio bearer(s), LCH(s) or LCG(s), it may determine whether there is any data buffered for the one or more radio bearers, the one or more LCHs, or the one or more LCGs on which the current SDT procedure is established. Here, a radio bearer may include a signaling radio bearer (SRB), such as SRB1 or SRB2, or a data radio bearer (DRB) for SDT.

If there is data available for transmission, at block 215, the first device 110 performs the transmission on the grant to the second device 120 with at least a part of the available data conveyed or comprised in the transmission. If the first device 110 determines that no data is available for transmission on the grant, at block 220, the first device 110 further determines whether the transmission on the grant is to be skipped. According to example embodiments of the present disclosure, the first device may not always skip a grant if no data is available for transmission.

There may be various criteria to be applied by the first device 110 to determine whether a transmission on a grant is to be skipped or not in the case of having no available data for transmission. Generally, during a SDT procedure, skipping a grant may likely increase the probability of ending the SDT procedure by the second device 120. To avoid the signaling overhead, power consumption and complexity in initiating a new SDT procedure, the first device 110 may desire to maintain in the current SDT procedure, especially if subsequent data transmission and/or receiving is expected for the SDT procedure. The criteria applied by the first device 110 to make the grant skipping decision will be described in detail below.

If it is determined that the grant is to be skipped, at block 225, the first device 110 causes the transmission to be skipped on the grant. In other words, no transmission is performed. The first device 110 may wait for a subsequent grant or wait if the second device 120 transmits signaling to end the current SDT procedure.

If it is determined that the grant is not to be skipped, at block 230, the first device 110 performs the transmission on the grant to the second device 120. Since no data is available, the transmission performed does not convey any data, but convey a certain type of information. Such information is generated to allow the transmission to be performed on the grant. As such, by proactively transmitting certain information on the grant even if no data is available, there is a high probability that the initiated SDT procedure may not be ended and the first device 110 may thus have further chances transmit or receive data in the SDT procedure.

In some example embodiments, for each grant allocated for the SDT procedure or those grants allocated after the initial transmission, the first device 110 may determine whether this grant can be skipped or not.

As mentioned, the first device 110 may apply some criteria to determine whether a grant is to be skipped or not. In some example embodiments, the first device 110 may determine whether to skip the grant by determining whether subsequent data is expected to be communicated for the SDT procedure. If the first device 110 determines that subsequent data is expected to be transmitted to the second device 120 or subsequent data is expected to be received from the second device 120 in a near future, the first device 110 may determine not to skip the grant. In an example embodiment, the first device 110 may determine whether subsequent data on one or more radio bearers, LCHs, or LCGs for which the SDT procedure is enabled or configured.

In some example embodiments, the first device 110 may determine whether to skip the grant by determining when the subsequent data is expected to be communicated in the SDT procedure. If the subsequent data is not expected within a certain time period, the first device 110 may determine to skip the grant; otherwise, if the subsequent data is expected within the certain time period, the first device 110 may determine not to skip the grant. In particular, the first device 110 may determine that the subsequent data is expected after a certain time period (referred to as a “first time period” for the purpose of discussion). The first device 110 may further determine whether the first time period exceeds (larger than or equal to) a period threshold for grant skipping (referred to as a “first period threshold” or “Thr.1” for the purpose of discussion). In an example, if the first time period exceeds the first period threshold, the first device 110 may determine that the transmission on the grant is to be skipped. In an example, if the first time period is below (lower than or equal to) the first period threshold, the first device 110 may determine not to skip the transmission on the grant.

In some example embodiments, the first period threshold may be specified in the first device 110 or configurable by the second device 120. In the latter case, the first device 110 may receive, from the second device 120, configuration information indicating the first period threshold. In some example embodiments, the first period threshold may be set to be specific to the first device 110 or specific to a radio bearer or a logical channel on which the SDT procedure is established. In the case that the first period threshold is set per radio bearer or per logical channel, the first device 110 may predict when subsequent data is expected for each radio bearer or each logical channel for which SDT is enabled or configured and compare the predicted time period with the first period threshold specific to that radio bearer or that logical channel.

The first period threshold may be defined in various ways. In some example embodiments, the first period threshold may be defined as a threshold number of time units, for example, X1 ms, X1 μs, X1 seconds (where X1 is a threshold number), or the like. Alternatively, the first period threshold may be defined as a threshold number of grant occasions or cycles, for example, N1 grant occasions (where N1 is a threshold number). The first time period for the expected subsequent data may also be measured with the corresponding time units or grant occasions so as to be compared with the first period threshold.

In some example embodiments, the second device 120 may configure the first period threshold to the first device 110 based on one or more Quality of Service (QOS) flow identity (QFIs) of the one or more radio bearers for which SDT is enabled or configured. The QFIs may indicate the latency requirements on the data communicated over the radio bearers. The second device 120 may determine the value for the first period threshold based on the latency requirements, so as to control how the grant skipping by the first device 110. For example, for a radio bearer used to communicate data having a strict latency requirement, the second device 120 may configure the first period threshold to be a relatively large value so that the first device 110 may skip the grant to attempt to maintain the SDT procedure for subseq978uent data communication.

In some example embodiments, as an alternative or in addition, the first period threshold may be configured based on historical data communication behaviors related to the first device 110. For example, if the second device 120 observes that the first device 110 previously transmitted and/or received data for multiple times with a relatively large periodicity in a SDT procedure, the second device 120 may configure the first period threshold to be a relatively large value.

In some example embodiments, the first device 110 may perform the prediction of the subsequent data (for example, whether or when the subsequent data is expected) based on historical behavior information about a particular application (e.g., a status update of a running application at a fixed interval), a radio bearer, a Quality of Service (QOS) flow identity (QFI), or the like. In some example embodiments, the prediction of the subsequent data may rely on a sensor(s) and/or a receiver(s) to which the first device 110 has access. For example, depending on location information, such as global positioning system (GPS) coordinates, it may be able to determine that the first device 110 is located at or approaches to an area where data is usually triggered to be transmitted and/or received.

In addition to the prediction of the subsequent data, or as an alternative, the first device 110 may determine whether to skip the grant by determining a time period from which no transmission is performed for the SDT procedure. In some example embodiments, the first device 110 may be allowed to skip one or more grants in a SDT procedure. The first device 110 may be specified or configured by the second device 120 with how many grant skip(s) may lead to the end of the SDT procedure. For example, the first device 110 may be specified or configured with a period threshold for grant skipping (referred to as a “second period threshold” or “Thr.2” for the purpose of discussion).

To determine whether a transmission on a grant is to be skipped, the first device 110 may determine a time period from a last grant on which a last transmission is performed during the SDT procedure. For the purpose of discussion, the time period is referred to as a “second time period.” The last transmission may be an initial transmission of the SDT procedure, a subsequent transmission comprising data, or a transmission comprising no data but a certain type of information because the first device 110 determines that the last grant is not to be skipped.

The first device 110 may compare the second time period with the second period threshold. In an example, if the second time period exceeds (larger than or equal to) the second period threshold, which means that the first device 110 performs no transmission for a long time or has skipped a number of grants, then the first device 110 may determine that the current grant is not to be skipped, especially when the first device 110 expects to continue the SDT procedure for subsequent data communication. In an example, if the second time period is below (lower than or equal to) the second period threshold, the first device 110 may determine to skip the transmission on the grant.

Similarly with the first period threshold, the second period threshold may be specified in the first device 110 or configurable by the second device 120. For example, the first device 110 may receive, from the second device 120, configuration information indicating the first period threshold. In some example embodiments, the second period threshold may be set to be specific to the first device 110 or specific to a radio bearer or a logical channel on which the SDT procedure is established. In the case that the second period threshold is set per radio bearer or per logical channel, the first device 110 may predict when subsequent data is expected for each radio bearer or each logical channel for which SDT is enabled or configured and compare the predicted time period with the second period threshold specific to that radio bearer or that logical channel.

The second period threshold may be defined in various ways. In some example embodiments, the second period threshold may be defined as a threshold number of time units, for example, X2 ms, X2 μs, X2 seconds (where X2 is a threshold number), or the like. Alternatively, the second period threshold may be defined as a threshold number of grant occasions or cycles, for example, N2 grant occasions (where N2 is a threshold number). The second time period between the last grant on which the last transmission is performed and the current grant may also be measured with the corresponding time units or grant occasions so as to be compared with the second period threshold.

In some example embodiments, by specifying or configuring the second period threshold, the first device 110 may be able to determine how many grant skip(s) will lead to the end of the SDT procedure (e.g., after N2 grant occasions or X2 ms). As such, the first device 110 may skip (N2-1) grants occasions after the last transmission if no data is available, and may perform the transmission without conveying data on the N-th grant. Alternatively, the first device 110 may measure the time duration from the last transmission to the current grant and perform the transmission on the current grant if the time duration exceeds X2 ms.

It has been discussed above some criteria applied in determining whether a grant can be skipped or not. It would be appreciated that one or more other criteria may be configured by the second device 120 or applied by the first device 110 to determine whether a grant can be skipped or not. In some example embodiments, the first device 110 may be enabled to always skip a grant even if no data is available during the SDT procedure, or skip no grant by always performing a transmission without data on the grant.

In would also be appreciated that the first device 110 may apply any one of the above criteria individually or apply a combination of the above different criteria, to decide whether a transmission on a grant is to be skipped or not. The scope of the present disclosure is not limited in this regard. For example, the first device 110 may apply the second period threshold to check whether it has skipped a threshold number of grants and also check whether subsequent data is to be transmitted to and/or received from the second device 120. A transmission on a grant is to be skipped in the case that the second time period exceeds the second period threshold and the subsequent data is expected (is expected within the first period threshold). In another example, if the first device 110 determines that the grants are not skipped for a long time period (the second time period does not exceed the second period threshold), it may not need to predict whether or when the subsequent data is expected.

In some example embodiments, it may be configurable by the second device 120 about whether the first device 110 can perform the grant skipping as described above. The first device 110 may receive enablement information from the second device 120, which indicates whether skipping of at least one grant is enabled for the first device 110 during the SDT procedure. If the enablement information indicates that the skipping of the at least one grant is enabled, the first device 110 may apply one or more of the above-mentioned criteria to skip or not skip a grant during the SDT procedure. In some example embodiments, the enablement information may be signaled via system information (SI), via RRC Release with suspend configuration when the first device 110 is transited to INACTIVE mode, or any other information transmitted to the first device 110. By enabling or disabling the grant skipping, the second device 120 may be able to control communication in the system. For example, in the case of overload, the second device 120 may disable the skipping of the grant(s) to be performed by some of first devices 110. As such, the second device 120 may not receive transmissions without data from the first devices 110. In some example embodiments, the second device 120 may provide the enablement information per bandwidth part (BWP), to enable or disable the grant skipping for one or more first devices 110 on different BWPs.

In some example embodiments, the configuration information for grant skipping (e.g., the configuration of the first and/or second period thresholds, or other criteria for grant skipping) may be configured from the second device 120 via the system information, via RRC Release with suspend configuration when the first device 110 is transited to INACTIVE mode, or any other type of signaling. The configuration information may be provided from the second device 120 when the first device 110 is enabled to skip one or more grants during the SDT procedure. In some example embodiments, if the criteria for grant skipping such as the first and/or second period thresholds are specified at the first device 110, the first device 110 may apply the criteria when it is enabled to skip one or more grants during the SDT procedure.

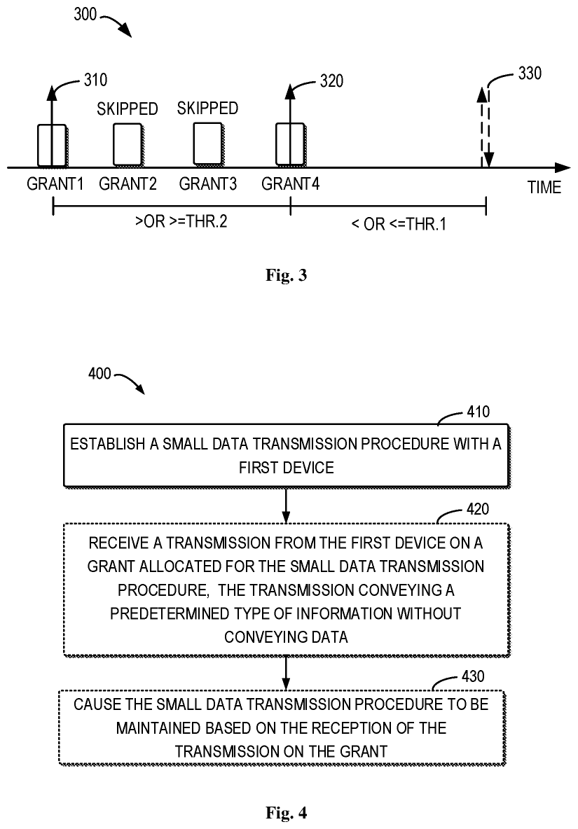

To better understand the grant skipping, FIG. 3 illustrates an example 300 of grant skipping at the first device 110 according to some example embodiments of the present disclosure. As illustrated, the first device 110 performs a transmission 310 on a grant denoted as “Grant1” during a SDT procedure. It is noted that the transmission 310 may be an initial transmission of the SDT procedure, a subsequent transmission comprising data, or a transmission comprising no data but a certain type of information. At the time of a grant denoted as “Grant2,” the first device 110 has no available data to be transmitted, so it may determine that a time period from Grant1 on which the last transmission to the second device 120 is performed to Grant2 is below the second period threshold denoted as “Thr.2.” In such a case, the first device 110 may determine to skip a transmission on Grant2. In some examples, if the first device 110 determines that Grant2 is close to Grant1 (e.g., the time period from Grant1 to Grant2 is relatively small), it may not need to predict whether or when there is subsequent data to be communicated but may directly decide to skip the transmission on Grant2. At the time of a grant denoted as “Grant3,” the first device 110 may also determine to skip the transmission according to a similar criterion.

At the time of a grant denoted as “Grant4,” the first device 110 may determine that a time period from Grant1 to Grant2 exceeds (larger than or equal to) the second period threshold of “Thr.2.” In addition, or as an alternative, the first device 110 may determine whether subsequent data is to be communicated for the SDT procedure. In the shown example, it is assumed that the first device 110 predicts that subsequent data 330 (a data transmission to or a data reception from the second device) is expected at a future time. The first device 110 may further determine that a time period from Grant4 to the time when the subsequent data 330 is expected is below (lower than or equal to) the first period threshold for grant skipping which is denoted as “Thr.1.” In this case, the first device 110 may determine not to skip the transmission on this grant. It would be appreciated that in some other examples, the first device 110 may apply only the second period threshold of “Thr.2” or the first period threshold of “Thr.1” at the time of “Grant4.” The scope of the present disclosure is not limited in this regard.

Upon determining not to skip the transmission on Grant4, the first device 110 may proactively perform a transmission 320 on Grant4 although the first device 110 still having no available data at this time. In order not to skip Grant4, a certain type of information may be generated and conveyed in the transmission.

As mentioned above, since no data is available but the current grant is not supposed to be skipped, the first device 110 may embed a certain type of information into the transmission to be performed on the grant. In some example embodiments, if the first device 110 determines that the current grant is not to be skipped, a buffer status report (BSR) or a power headroom report (PHR) may be conveyed in the transmission performed on the grant. In some example embodiments, a new type of periodic PHR or padding PHR may be defined which has lower priority than data and is only included when there is space in the grant, e.g. when no data available for transmission. A timer may be (re) started upon each transmission, and at expiry of the timer such PHR is triggered. When the timer is (re) started upon a transmission, such triggered PHR is cancelled regardless if the transmission includes PHR or not.

In some example embodiments, the first device 110 may comprise indication information in the transmission, to indicate to the second device 120 that subsequent data is expected to be received from and/or transmitted to the second device 120, or to indicate to the second device 120 that the first device 110 expects to continue the SDT procedure.

In some example embodiments, the indication information may include an indication (referred to as a “first indication” for the purpose of discussion) to indicate that subsequent data is expected to be communicated during the small data transmission procedure. As an example, the first indication may comprise one bit to indicate that the subsequent data is expected.

In some example embodiments, the indication information may include an indication (referred to as a “second indication” for the purpose of discussion) of at least one radio bearer, at least one LCH, or at least one LCG on which the subsequent data is expected to be communicated. In some example embodiments, the second indication may include identity information about the at least one radio bearer, at least one LCH, or at least one LCG on which the subsequent data is expected to be communicated, such as the at least one radio bearer identity (ID), LCH identity (LCID), or LCG ID. In some example embodiments, the second indication may comprise a bitmap with each bit corresponding to a radio bearer, a LCH, or a LCG. Different values of the bit (0 or 1) may be used to indicate whether the subsequent data is expected to be communicated on the corresponding radio bearer, the LCH, or the LCG.

In some example embodiments, the bitmap may include bits corresponding to one or more radio bearers, LCHs, or LCGs on which the SDT is enabled or configured for the first device 110. In some example embodiments, the bitmap may include bits corresponding to all the radio bearers, LCHs, or LCGs for the first device 110. In some example embodiments, the mapping between the bits in the bitmap and the bearers, LCHs, or LCGs may be either implicit (e.g., the first bit corresponds to a radio bearer or LCH with the lowest radio bearer ID, LCID, or LCG ID, the second bit corresponds to a radio bearer or LCH with the second lowest radio bearer ID, LCID, or LCG ID, and so on) or may be explicitly configured.

In some example embodiments, if it is possible for the first device 110 to determine an amount of the subsequent data expected to be communicated, the indication information may alternatively or additionally include an indication (referred to as a “third indication” for the purpose of discussion) of the amount of the expected subsequent data. In some example embodiments, the third indication may be indicated using a same format as a regular BSR but with a field (such as a LCID) to indicate that it is a prediction.

In some example embodiments, if it is possible for the first device 110 to determine a time when the subsequent data is expected to be communicated, the indication information may include an indication (referred to as a “fourth indication” for the purpose of discussion) of the time when the subsequent data is expected. The time may be indicated in various ways. As a specific example, the fourth indication may indicate the number of slots to indicate a time period for which the subsequent data is expected. Of source, it is feasible to indicate the time when the subsequent data is expected in various other ways.

As an alternative, in some cases, the first device 110 may generate a transport block (TB) with dummy bits (padding bits) and transmit such a TB to the second device 120 on the grant. Upon reception of such a special TB from the first device 110, the second device 120 may determine that the first device 110 has no data to be transmitted on the current grant but still want to continue the SDT procedure in case of subsequent data arriving.

In some example embodiments, in order to perform the transmission on the grant, the first device 110 (e.g., a media access control (MAC) entity of the first device 110) may generate a packet data unit (PDU), such as a MAC PDU. One or more above-mentioned information may be included in the MAC PDU. In some example embodiments, the indication information may be included in a MAC control element (CE) in the MAC PDU. The size of the MAC CE may depend on which indications are to be conveyed to the second device 120. In the case of transmitting the first indication, a MAC CE without payload may be used to indicate that the subsequent data is expected.

In some example embodiments, the first device 110 may embed different types of information or a same type of information into the transmissions performed on different grants in the case of having no data to transmit. In some example embodiments, the first device 110 may embed two or more types of information into a same transmission. The scope of the present disclosure is not limited in this regard.

FIG. 4 shows a flowchart of an example process 400 implemented at a second device in accordance with some example embodiments of the present disclosure. For the purpose of discussion, the process 400 will be described from the perspective of the second device 120 with respect to FIG. 1.

At block 410, the second device 120 establishes a SDT procedure with the first device 110. At block 420, the second device 120 receives, from the first device 110, a transmission on a grant allocated for the SDT procedure. The transmission conveys the certain type of information as described above, without conveying the data. At block 430, the second device 120 causes the SDT procedure to be maintained based on the reception of the transmission on the grant.

In some example embodiments, the second device 120 may determine to maintain the SDT procedure upon receiving of the transmission on the grant. In some example embodiments, the second device 120 may determine whether to maintain or end the SDT procedure based on the reception of the transmission, the information comprised in the transmission, and/or one or more other factors.

In some example embodiments, if one or more indications about the subsequent data are comprised in the received transmission, the second device 120 may explicitly determine that the first device 110 may expect to continue the SDT procedure to allow subsequent data communication. As such, the second device 120 may not end the SDT procedure. In some example embodiments, if some other types of information, such as BSR, PHR, and/or some dummy information (a TB with dummy bits) is comprised in the transmission, the second device 120 may interpret the received information as explicitly indicating that subsequent data is expected to be communicated during the SDT procedure, and thus may decide whether to maintain or end the SDT procedure.

In some example embodiments, the second device 120 may make the decision about maintaining or ending the SDT procedure based on one or more other factors (e.g., whether the cell is overloaded or not) than the transmission received on the grant. In such a case, by taking the other factor(s) into account, the second device 120 may determine not to maintain the SDT procedure even if the first device 110 performs the transmission on the grant. For example, if the indication information comprised in the transmission indicates that the subsequent data is expected within a relatively long time period (longer than a threshold), then the second device 120 may determine not to maintain the SDT procedure considering the heavy workload in the system.

In some example embodiments, if the second period threshold as mentioned above is configured or specified to the first device 110 for grant skipping, during the SDT procedure, the second device 120 may determine a time period from a first grant on which a last transmission is received from the first device 110 to a second grant on which no transmission is received from the first device 110. The second device 120 may be aware of which grants are allocated for the SDT procedure established with the first device 110.

For any second allocated grant on which no transmission is received, the second device 120 may determine whether the determined time period exceeds the second period threshold. If the time period is below (smaller than or equal to the second period threshold), the second device 120 may determine to maintain the SDT procedure because the first device 110 is allowed to skip one or more grants within a pre-configured or pre-specified time period. Still referring to the example of FIG. 3, at the time of Grant2 or Grant3, the second device 120 receives no transmission on either of the two grants because the first device 110 skips the transmissions. Since the time period from Grant1 on which a previous transmission is received to Grant2 or Grant3 is lower than the second period threshold “Thr.2,” the second device 120 may

According to the behavior of the first device 110, when the second device 120 receives the transmission conveying no data from the first device 110, a time period from the first grant on which a last transmission is received to the current grant may exceed the second period threshold.

In some example embodiments, a first apparatus capable of performing any of the process 200 (for example, the first device 110) may comprise means for performing the respective operations of the process 200. The means may be implemented in any suitable form. For example, the means may be implemented in a circuitry and/or software module. The first apparatus may be implemented as or included in the first device 110.

In some example embodiments, the first apparatus comprises means for determining whether data is available for transmission on a grant, the grant being allocated for a small data transmission procedure established between the first apparatus and a second apparatus (for example, the second device 120); means for, in accordance with a determination that the data is unavailable, determining whether the transmission on the grant is to be skipped; and means for, in accordance with a determination that the transmission on the grant is not to be skipped, performing the transmission on the grant to the second apparatus, the transmission conveying a predetermined type of information without conveying the data.

In some example embodiments, the first apparatus further comprises means for, in accordance with a determination that the transmission on the grant is to be skipped, causing the transmission on the grant to be skipped.

In some example embodiments, the means for determining whether the transmission on the grant is to be skipped comprises: means for receiving, from the second apparatus, enablement information indicating whether skipping of at least one grant is enabled for the first apparatus during the small data transmission procedure; and means for in accordance with a determination that the enablement information indicates that skipping of the at least one grant is enabled for the first apparatus and a determination that the data is unavailable, determining whether the transmission on the grant is to be skipped.

In some example embodiments, the means for determining whether the transmission on the grant is to be skipped comprises: means for determining that subsequent data is expected to be communicated after a first time period during the small data transmission procedure; means for determining whether the first time period exceeds a first period threshold for grant skipping; and means for in accordance with a determination that the first time period exceeds the first period threshold, determining that the transmission on the grant is to be skipped.

In some example embodiments, the means for determining whether the transmission on the grant is to be skipped comprises: means for determining whether a second time period from a last grant on which a last transmission is performed during the small data transmission procedure to the grant exceeds a second period threshold for grant skipping; and means for in accordance with a determination that the second time period exceeds the second period threshold, determining that the transmission on the grant is not to be skipped.

In some example embodiments, the first apparatus further comprises means for receiving, from the second apparatus, configuration information indicating at least one of the first period threshold and the second period threshold.

In some example embodiments, at least one of the first period threshold and the second period threshold is set to be specific to the first apparatus or specific to a radio bearer or a logical channel on which the small data transmission procedure is established.

In some example embodiments, at least one of the first period threshold and the second period threshold is defined as a threshold number of time units or a threshold number of grant occasions.

In some example embodiments, the predetermined type of information conveyed in the transmission on the grant comprises at least one of the following: a first indication indicating that subsequent data is expected to be communicated during the small data transmission procedure, a second indication of at least one radio bearer or at least one logical channel on which the subsequent data is expected to be communicated, a third indication of an amount of the subsequent data expected to be communicated, a fourth indication of a time when the subsequent data is expected to be communicated, a buffer status report, a power headroom report, and a transport block with dummy bits.

In some example embodiments, the first apparatus further comprises means for performing other operations in some example embodiments of the process 200 or the first device 110. In some example embodiments, the means comprises at least one processor; and at least one memory including computer program code, the at least one memory and computer program code configured to, with the at least one processor, cause the performance of the first apparatus.

In some example embodiments, a second apparatus capable of performing any of the process 400 (for example, the second device 120) may comprise means for performing the respective operations of the process 400. The means may be implemented in any suitable form. For example, the means may be implemented in a circuitry and/or software module. The second apparatus may be implemented as or included in the second device 120.

In some example embodiments, the second apparatus comprises means for establishing a small data transmission procedure with a first apparatus (for example, the first device 110); means for receiving, from the first apparatus on a grant allocated for the small data transmission procedure, a transmission conveying a predetermined type of information without conveying data; and means for causing the small data transmission procedure to be maintained based on the reception of the transmission on the grant.

In some example embodiments, the predetermined type of information conveyed in the transmission on the grant comprises at least one of the following: a first indication indicating that subsequent data is expected to be communicated during the small data transmission procedure, a second indication of at least one radio bearer or at least one logical channel on which the subsequent data is expected to be communicated, a third indication of an amount of the subsequent data expected to be communicated, a fourth indication of a time when the subsequent data is expected to be communicated, a buffer status report, a power headroom report, and a transport block with dummy bits.

In some example embodiments, the second apparatus further comprises: means for determining a time period from a first grant on which a last transmission is received from the first apparatus, to a second grant on which no transmission is received from the first apparatus, the first and second grants being allocated for the small data transmission procedure; and means for, in accordance with a determination that the time period is below a second period threshold for grant skipping, causing the small data transmission procedure to be maintained.

In some example embodiments, a time period from the first grant to the grant exceeds the second period threshold.

In some example embodiments, the second apparatus further comprises: means for transmitting, to the first apparatus, configuration information indicating at least the second period threshold.

In some example embodiments, the second apparatus further comprises: means for transmitting, to the first apparatus, enablement information indicating whether skipping of at least one grant is enabled for the first apparatus during the small data transmission procedure.

In some example embodiments, the second apparatus further comprises means for performing other operations in some example embodiments of the process 400 or the second device 120. In some example embodiments, the means comprises at least one processor; and at least one memory including computer program code, the at least one memory and computer program code configured to, with the at least one processor, cause the performance of the second apparatus.

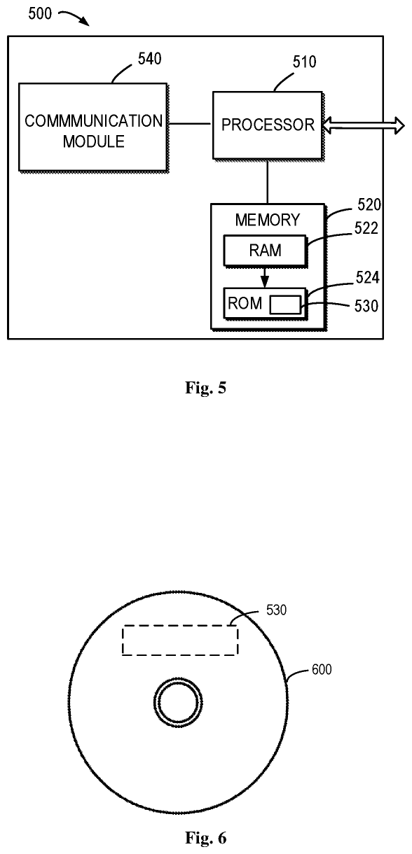

FIG. 5 is a simplified block diagram of a device 500 that is suitable for implementing example embodiments of the present disclosure. The device 500 may be provided to implement a communication device, for example, the first device 110 or the second device 120 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the memory, e.g., ROM 524. The processor 510 may perform any suitable actions and processing by loading the program 530 into the RAM 522.

The example embodiments of the present disclosure may be implemented by means of the program 530 so that the device 500 may perform any process of the disclosure as discussed with reference to FIGS. 2 to 4. The example embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 which may be in form of CD, DVD or other optical storage disk. The computer readable medium has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 2 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory including computer program code;
wherein the at least one memory and the computer program code are configured to, with the at least one processor, cause the first device to:
determine whether data is available for transmission on a grant, the grant being allocated for a small data transmission procedure established between the first device and a second device;
in accordance with a determination that the data is unavailable, determine whether the transmission on the grant is to be skipped; and
in accordance with a determination that the transmission on the grant is not to be skipped, perform the transmission on the grant to the second device, the transmission conveying a predetermined type of information without conveying the data.

2. The first device of claim 1, wherein the at least one memory and the computer program code are configured to, with the at least one processor, further cause the first device to:
in accordance with a determination that the transmission on the grant is to be skipped, cause the transmission on the grant to be skipped.

3. The first device of claim 1, wherein the at least one memory and the computer program code are configured to, with the at least one processor, cause the first device to determine whether the transmission on the grant is to be skipped by:
receiving, from the second device, enablement information indicating whether skipping of at least one grant is enabled for the first device during the small data transmission procedure; and
in accordance with a determination that the enablement information indicates that skipping of the at least one grant is enabled for the first device and a determination that the data is unavailable, determining whether the transmission on the grant is to be skipped.

4. The first device of claim 1, wherein the at least one memory and the computer program code are configured to, with the at least one processor, cause the first device to determine whether the transmission on the grant is to be skipped by:
determining that subsequent data is expected to be communicated after a first time period during the small data transmission procedure;
determining whether the first time period exceeds a first period threshold for grant skipping; and
in accordance with a determination that the first time period exceeds the first period threshold, determining that the transmission on the grant is to be skipped.

5. The first device of claim 1, wherein the at least one memory and the computer program code are configured to, with the at least one processor, cause the first device to determine whether the transmission on the grant is to be skipped by:
determining whether a second time period from a last grant on which a last transmission is performed during the small data transmission procedure to the grant exceeds a second period threshold for grant skipping; and
in accordance with a determination that the second time period exceeds the second period threshold, determining that the transmission on the grant is not to be skipped.

6. The first device of claim 4, wherein the at least one memory and the computer program code are configured to, with the at least one processor, further cause the first device to: receive, from the second device, configuration information indicating at least one of the first period threshold and the second period threshold.

7. The first device of claim 4, wherein at least one of the first period threshold and the second period threshold is set to be specific to the first device or specific to a radio bearer or a logical channel on which the small data transmission procedure is established.

8. The first device of claim 4, wherein at least one of the first period threshold and the second period threshold is defined as a threshold number of time units or a threshold number of grant occasions.

9. The first device of claim 1, wherein the predetermined type of information conveyed in the transmission on the grant comprises at least one of the following:
a first indication indicating that subsequent data is expected to be communicated during the small data transmission procedure,
a second indication of at least one radio bearer or at least one logical channel on which the subsequent data is expected to be communicated,
a third indication of an amount of the subsequent data expected to be communicated,
a fourth indication of a time when the subsequent data is expected to be communicated,
a buffer status report,
a power headroom report, and
a transport block with dummy bits.

10. A second device comprising:
at least one processor; and
at least one memory including computer program code;
wherein the at least one memory and the computer program code are configured to, with the at least one processor, cause the second device to:
establish a small data transmission procedure with a first device;
receive, from the first device on a grant allocated for the small data transmission procedure, a transmission conveying a predetermined type of information without conveying data; and
cause the small data transmission procedure to be maintained based on the reception of the transmission on the grant.

11. The second device of claim 10, wherein the predetermined type of information conveyed in the transmission on the grant comprises at least one of the following:
a first indication indicating that subsequent data is expected to be communicated during the small data transmission procedure,
a second indication of at least one radio bearer or at least one logical channel on which the subsequent data is expected to be communicated,
a third indication of an amount of the subsequent data expected to be communicated,
a third indication of a time when the subsequent data is expected to be communicated,
a buffer status report,
a power headroom report, and
a transport block with dummy bits.

12. The second device of claim 10, wherein the at least one memory and the computer program code are configured to, with the at least one processor, further cause the second device to:
determine a time period from a first grant on which a last transmission is received from the first device, to a second grant on which no transmission is received from the first device, the first and second grants being allocated for the small data transmission procedure; and
in accordance with a determination that the time period is below a second period threshold for grant skipping, cause the small data transmission procedure to be maintained.

13. The second device of claim 12, wherein a time period from the first grant to the grant exceeds the second period threshold.

14. The second device of claim 12, wherein the at least one memory and the computer program code are configured to, with the at least one processor, further cause the second device to:
transmit, to the first device, configuration information indicating at least the second period threshold.

15. The second device of claim 10, wherein the at least one memory and the computer program code are configured to, with the at least one processor, further cause the second device to:
transmit, to the first device, enablement information indicating whether skipping of at least one grant is enabled for the first device during the small data transmission procedure.

16. A method comprising:
determining, at a first device, whether data is available for transmission on a grant, the grant being allocated for a small data transmission procedure established between the first device and a second device;
in accordance with a determination that the data is unavailable, determining whether the transmission on the grant is to be skipped; and
in accordance with a determination that the transmission on the grant is not to be skipped, performing the transmission on the grant to the second device, the transmission conveying a predetermined type of information without conveying the data.

17. The method of claim 16, wherein determining whether the transmission on the grant is to be skipped comprises:
receiving, from the second device, enablement information indicating whether skipping of at least one grant is enabled for the first device during the small data transmission procedure; and
in accordance with a determination that the enablement information indicates that skipping of the at least one grant is enabled for the first device and a determination that the data is unavailable, determining whether the transmission on the grant is to be skipped.

18. The method of claim 16, wherein determining whether the transmission on the grant is to be skipped comprises:
determining that subsequent data is expected to be communicated after a first time period during the small data transmission procedure;
determining whether the first time period exceeds a first period threshold for grant skipping; and
in accordance with a determination that the first time period exceeds the first period threshold, determining that the transmission on the grant is to be skipped.

19. The method of claim 16, wherein determining whether the transmission on the grant is to be skipped comprises:
determining whether a second time period from a last grant on which a last transmission is performed during the small data transmission procedure, to the grant exceeds a second period threshold for grant skipping; and
in accordance with a determination that the second time period exceeds the second period threshold, determining that the transmission on the grant is not to be skipped.

20. The method of claim 16, wherein the predetermined type of information conveyed in the transmission on the grant comprises at least one of the following:
a first indication indicating that subsequent data is expected to be communicated during the small data transmission procedure,
a second indication of at least one radio bearer or at least one logical channel on which the subsequent data is expected to be communicated,
a third indication of an amount of the subsequent data expected to be communicated,
a fourth indication of a time when the subsequent data is expected to be communicated,
a buffer status report,
a power headroom report, and
a transport block with dummy bits.

21-25. (canceled)
